(19) United States
(12) Patent Application Publication
(10) Pub. No.: US 2024/0238946 A1
(43) Pub. Date: Jul. 18, 2024

(54) WRENCH TOOL

(71) Applicant: LERN TIM TOOLS CO., LTD., Taichung City (TW)

(72) Inventor: QING-YONG LIAO, Taichung City (TW)

(21) Appl. No.: 18/411,344

(22) Filed: Jan. 12, 2024

(30) Foreign Application Priority Data
Jan. 13, 2023 (TW) 112200511

(51) Int. Cl. B25B 13/06

(52) U.S. Cl. CPC B25B 13/065

(57) ABSTRACT

A wrench tool is provided, wherein the wrench tool includes: a main body; a receiving hole formed from a first outer side of the main body in a first direction; and a plurality of teeth each projecting from the main body in a second direction perpendicular to the first direction, projecting inward in the receiving hole, and extending in a longitudinal direction, the longitudinal direction and the second direction being contained in a same plane.

### BACKGROUND OF THE INVENTION

### Field of the Invention

The present invention relates to a wrench tool.

### Description of the Prior Art

Conventionally, a fastener, such as a nut on a bolt or screw was turned by using a tool to lock the fastener on an object. However, the fastener could be often damaged due to excessive force when turning the tool, which makes it difficult to drive and rotate the fastener. Therefore, there will be problems that the fastener cannot be removed from the object or are easily damaged, causing inconvenience during operation.

The present invention is, therefore, arisen to obviate or at least mitigate the above-mentioned disadvantages.

### SUMMARY OF THE INVENTION

The main object of the present invention is to provide a wrench tool which is easy to operate and can be used to remove a fastener from an object easily without causing damage to the fastener.

To achieve the above and other objects, a wrench tool is provided, wherein the wrench tool includes: a main body; a receiving hole formed from a first outer side of the main body in a first direction; and a plurality of teeth each projecting from the main body in a second direction perpendicular to the first direction, projecting inward in the receiving hole, and extending in a longitudinal direction, the longitudinal direction and the second direction being contained in a same plane.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a top view of an exemplary embodiment of the present invention;

FIG. 3 is a bottom view of an exemplary embodiment of the present invention;

FIG. 4 is a drawing showing an application of an exemplary embodiment of the present invention; and

FIG. 5 is a cross-sectional view of an exemplary embodiment of the present invention.

### DETAILED DESCRIPTION OF THE PREFERRED EMBODIMENTS

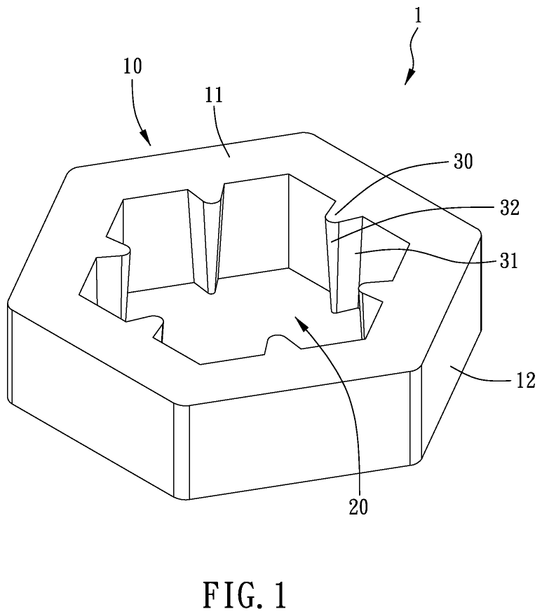

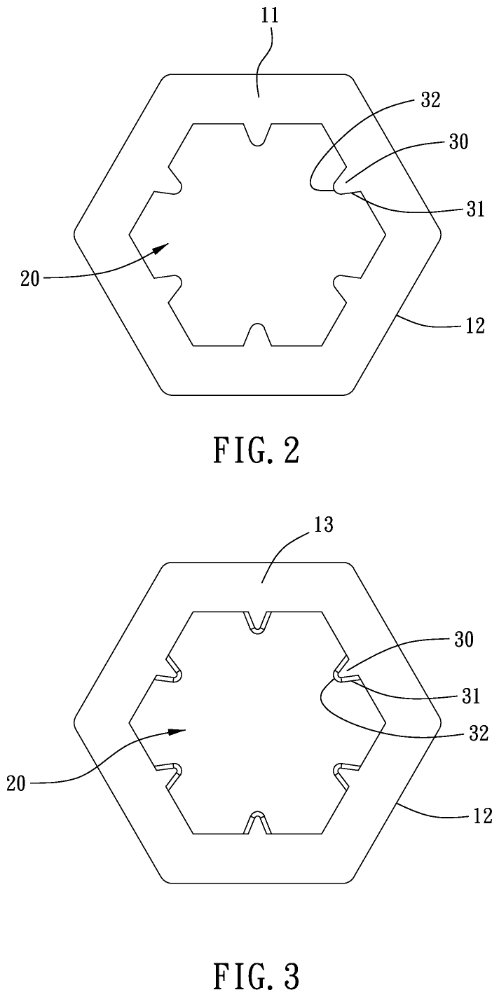

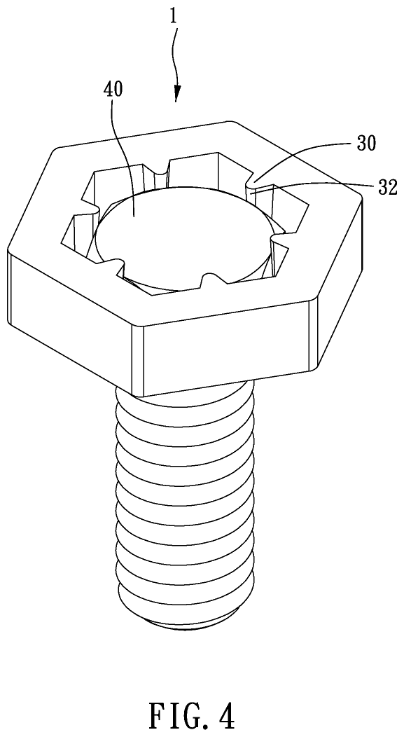

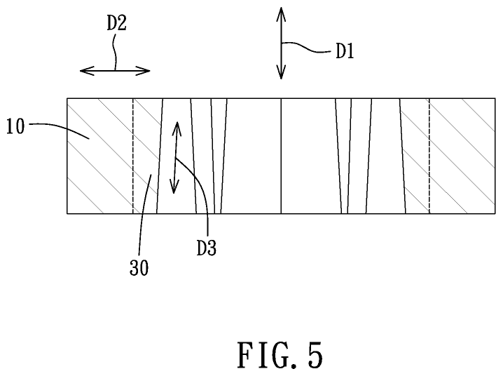

Please refer to FIGS. 1 to 5 for an exemplary embodiment of the present invention. A wrench tool 1 of the present invention includes a main body 10, a receiving hole 20 and a plurality of teeth 30.

The receiving hole 20 is formed from a first outer side 11 of the main body 10 in a first direction D1. Each the plurality of teeth 30 projects from the main body 10 in a second direction D2 perpendicular to the first direction D1, projects radially inward in the receiving hole 20, and extends in a longitudinal direction D3. The longitudinal direction D3 and the second direction D2 are contained in (located on) a same plane. The wrench tool 1 may include an odd number (3, 5, 7, or more) or even number (2, 4, 6, or more) of said teeth 30. Whereby, the wrench tool 1 is easy to operate, and can be used to remove a fastener 40 (a bolt, nut or the like) from an object easily without causing damage to the fastener 40.

In this embodiment, the main body 10 extends annularly around the first direction D1, and the main body 10 has a polygonal outer surface 12 (such as a hexagonal outer surface, pentagonal outer surface, or the like) around the first direction D1. However, the main body 10 maybe open in the second direction D2, the main body 10 may have a rounded outer surface around the first direction D1, or the main body 10 may have a non-rounded outer surface around the first direction D1. The wrench tool 1 maybe served as a drive adaptor engaged on the drive head of an un-damaged or damaged fastener so that the wrench tool 1 can be driven by a wrench, socket, pliers, clamper or the like, the wrench tool 1 may include a closed-end wrench, an open-end wrench, both a closed-end wrench and an open-end wrench, or a socket wrench.

The receiving hole 20 maybe polygonal (hexagonal, pentagonal, or the like), and the receiving hole 20 is disposed through the main body 10. However, the receiving hole 20 maybe rounded, or the receiving hole 20 maybe a blind hole. Each of the plurality of teeth 30 extends in the first direction D1 from the first outer side 11 of the main body 10 to a second outer side 13 of the main body 10 opposite to the first outer side 11 of the main body 10, which provides a large compatibility of engagement for various fasteners of different sizes.

Preferably, the main body 10 and the plurality of teeth 30 are made of stainless steel, and the main body 10 and the plurality of teeth 30 are integrally formed of one piece, so that it has greater structural strength and durability. The plurality of teeth 30 are preferably equidistantly arranged around the first direction D1, which can distribute the force applied on the fastener and prevent the fastener from being damaged by the plurality of teeth 30. Preferably, each of the plurality of teeth 30 has a width smaller than or equal to 0.25 times of a diametric dimension of the receiving hole 20. For example, each of the plurality of teeth 30 may have a width of 1/12, 1/10, ⅛, ⅙ or ¼ times of a diametric dimension of the receiving hole 20.

Specifically, each of the plurality of teeth 30 extends linearly in the longitudinal direction D3, which can engage with the fastener much effectively; each of the plurality of teeth 30 is tapered in the first direction D1, which provides a large compatibility of engagement for various fasteners of different sizes; and each of the plurality of teeth 30 includes two flat side surfaces 31 extending from the main body 10 and an arcuate ridge surface 32 connected to and between the two flat side surfaces 31, and the arcuate ridge surface 32 is a part of a conical surface, which is conducive to good engagement with the fastener and can avoid damage to the fastener.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wrench tool including:
a main body;
a receiving hole formed from a first outer side of the main body in a first direction; and
a plurality of teeth each projecting from the main body in a second direction perpendicular to the first direction, projecting inward in the receiving hole, and extending in a longitudinal direction, the longitudinal direction and the second direction being contained in a same plane.

2. The wrench tool of claim 1, wherein the main body extends annularly around the first direction.

3. The wrench tool of claim 1, wherein the main body has a polygonal outer surface around the first direction.

4. The wrench tool of claim 1, wherein the receiving hole is polygonal.

5. The wrench tool of claim 1, wherein each of the plurality of teeth is tapered in the first direction.

6. The wrench tool of claim 5, wherein each of the plurality of teeth includes two flat side surfaces extending from the main body and an arcuate ridge surface connected to and between the two flat side surfaces.

7. The wrench tool of claim 6, wherein the arcuate ridge surface is a part of a conical surface.

8. The wrench tool of claim 5, wherein each of the plurality of teeth is tapered in the second direction.

9. The wrench tool of claim 8, wherein each of the plurality of teeth includes two flat side surfaces extending from the main body and an arcuate ridge surface connected to and between the two flat side surfaces.

10. The wrench tool of claim 9, wherein the arcuate ridge surface is a part of a conical surface.

11. The wrench tool of claim 1, wherein the plurality of teeth are equidistantly arranged around the first direction.

12. The wrench tool of claim 1, wherein the receiving hole is disposed through the main body, and each of the plurality of teeth extends in the first direction from the first outer side of the main body to a second outer side of the main body opposite to the first outer side of the main body.

13. The wrench tool of claim 1, wherein each of the plurality of teeth extends linearly in the longitudinal direction.

14. The wrench tool of claim 1, wherein the main body and the plurality of teeth are integrally formed of one piece.

15. The wrench tool of claim 1, wherein the main body and the plurality of teeth are made of stainless steel.

16. The wrench tool of claim 1, wherein each of the plurality of teeth has a width smaller than or equal to 0.25 times of a diametric dimension of the receiving hole.
